(19) United States
(12) Patent Application Publication
(10) Pub. No.: US 2006/0155542 A1
(43) Pub. Date: Jul. 13, 2006

(54) Show & tell tech

(76) Inventors: Yves Attiogbe Vimegnon, Portland, OR (US); Kofi Nelson-Owusu, Hillsboro, OR (US)

Correspondence Address: YVES ATTIOGBE VIMEGNON, 4035 SE MALL STREET, PORTLAND, OR, 97202, US

(21) Appl. No.: 11/259,001

(22) Filed: Oct. 26, 2005

(51) Int. Cl. G10L 13/08

(52) U.S. Cl. 704/260

(57) ABSTRACT

A system and method for delivering instructions in an easy-to-understand format designated as “Show and Tell”—Tech (ST-Tech) Format. For people who cannot read and understand medications or health instructions, ST-Tech offers useful, effective and safety features based on color code, pictures, voice and icons to help ensure accuracy in the management or administration of medications. Just as some icons or signs have been made and became part of the rules of the road universally, this electronic “Show and Tell” electronic method is intended to simplify for the navigation through multiple medication regimens. Medical prescription processed into ST-Tech Format become conversions of the text entries of these prescriptions into visual and spoken instructions for the patients. ST-Tech will help millions of patients struggling with low health literacy and numeracy. Apart from medical prescriptions, the ST-Tech Formatting principle can also be useful in other medical or non-medical scheduled events or tasks.

### CROSS-REFERENCES

U.S. Patent Documents

| | | | |
|---|---|---|---|
| 810379 | Mar. 26, 2004 | Broadfield | 280/1 |
| 178585 | Jun. 24, 2002 | Mallams, et al | 206/534 |
| 681583 | May 2, 2001 | Gogolak | 707/104.1 |
| 930358 | Aug. 31, 2004 | Holland, et al | 705/3 |
| 751800 | Jan. 5, 2004 | Burkeen | 705/2 |
| 929987 | Aug. 15, 2001 | Yarin, et al | 340/573.1 |
| 803862 | Feb. 24, 1997 | Whaley | 705/3 |
| 20004 | Jul. 1, 2004 | Schlotterbeck, et al | 705/2 |
| 20020026330 | Feb. 28, 2002 | Klein | 705/3 |

### BACKGROUND OF THE INVENTION

The present invention pertains to the field of patient safety, specifically medication management or administration errors as they relate to patients health literacy challenges. Up to date most patient safety endeavors are focused on solutions from healthcare providers ends, ignoring that patients can also be empowered to get the most benefits from their prescribed medication regimens. This invention offers a system and method to enhance the effectiveness and accuracy of multiple medication regimens.

Medical errors in hospitals: A 1999 report of the Institute of Medicine (IOM), entitled “To Err Is Human: Building a Safer Health System,” gave the nation a wake-up call to the issue of medical errors and patient safety. The report indicated that as many as 44,000 to 98,000 people die in hospitals each year as the result of medical errors. About 7,000 people per year are estimated to die from medication errors alone—which is about 16 percent more deaths than the number attributable to work-related injuries. Preventable errors and complications involving prescription drugs alone are also responsible for billions of dollars in additional health care costs each year, in addition to all of the unnecessary suffering. The IOM report estimates that medical errors cost the nation about $37.6 billion each year; about $17 billion of those costs are associated with preventable errors. About half of the expenditures for preventable medical errors are for direct health care costs.

Inappropriate drug use in nursing homes: In a three-part report, “Prescription Drug Use in Nursing Homes” (OEI-06-96-00080, OEI-06-96-00081, OEI-06-96-00082), the Office of Inspector General, Department of Health and Human Services identified many widespread problems in long term care facilities, such as nursing homes. The study found that: 32 percent received three or more inappropriate drugs and 5 percent took seven or more; 23 percent of patient records indicated patients having been prescribed medications for which the records showed no orders or receipts to indicate the patient actually received the medication; 20 percent of residents' records indicated use of at least one drug generally considered to be inappropriate for the elderly; 14 percent of residents were taking over-the-counter medications without physician orders; 17 percent of residents were taking medications inappropriate for their dietary requirements.

FDA's proposed solution: To help mitigate these medication-related health risks, earlier this year 2003, FDA proposed a universal bar coding system for prescription medications and blood products. Coupled with bar code readers and electronic medical records, bar codes on drugs are expected to reduce the rate of medication errors that occur at the stage of dispensing and administering medications by half or more. Based on the published relationships between hospital admissions and adverse drug events, FDA has estimated that of 372,000 preventable adverse drug events per year in hospitals, bar code identifiers on drug products could be expected to avoid about 22 percent of these events. The average annual benefit of avoiding these events is $3.9 billion dollars in patient pain and suffering and direct treatment costs. According to the hospital industry and many health care purchasers, standard bar codes will speed the adoption of electronic health information systems by hospitals and other healthcare organizations, because the standardized codes increase the payoff from having electronic systems. FDA drug bar code rules will require manufacturers to put bar codes on individual drug doses by 2006. Six thousands plus hospitals in the U.S. are expected to spend $7.2 billion to acquire and install bar-code. technology. The FDA is expected to “standardize bar codes so no matter whom, health-care providers buy from, they can use a standardized database to tell what kind of medication it is.”

The Aging Factor: The older population is getting frailer because of the death postponement effect of medical advances. Despite recent evidence of declines in disability rates related to longevity, the need for Long Term Care (LTC) services, and proper medication management tools will continue to expand.

In 2000, there is an estimated 35 million people age 65 or older in the United States, accounting for almost 13 percent of the total population. By the year 2020, there will be more than 70 million older persons in the US. By 2030, it is projected that one in five people will be age 65 or older. The size of the older population is projected to double over the next 30 years, growing to 70 million by 2030. The older population is rapidly becoming more diverse as minorities live longer. For example in 1990, 13 percent of persons 65 years and older were minorities. This percentage is projected to rise to 25 percent by 2030, almost doubling in 35 years. Baby boomers, many of whom are now beginning to grapple in growing numbers with LTC concerns related to their parents, will begin to join the ranks of older Americans starting in 2011. By that time their own potential LTC needs will have taken on a measure of reality.

The number of drugs prescribed for patients increases as they age, and seniors are more likely to have cognitive or sensory disorders that increase the chance of miscommunication with their clinicians about how to take their medications and doses. Although seniors make up only 13% of the US population, they use about 30% of all prescribed medications and 40% of the over-the-counter. Yet, polypharmacy, the use of multiple medications, is not without risk. For example, while taking only two drugs increases the risk of an adverse effect by 6%, eight medications raise the risk by 100%. But many seniors over 65 of age have an average of five chronic conditions, which increase their risk of polypharmacy. The polypharmacy problem is further compounded when healthcare providers are not informed and therefore unaware of what medication is being consumed or how the prescribed medication is taken. The rate of non-compliance with prescribed treatment has been estimated to be between 25% and 59% in seniors and 50% in the aged with chronic conditions. In fact, the Healthy People 2000 Conference identified polypharmacy in older people with chronic health problems as the principal safety issue in the coming years.

Despite the growth of the older population, the United States is a relatively young country when compared with other developed nations. In many industrialized countries, older persons account for 15 percent or more of the total population. The need for medication management tools seems equally significant in these countries as well.

The Low Health Literacy Factor: The American Medical Association (AMA) Foundation highly praised, in January 2003, the report by the Institute of Medicine of the National Academies for identifying health literacy as one of the country's top priorities for improving the quality and delivery of health care.

Low health literacy is the inability to read, comprehend, and/or act appropriately on medical instructions. Low health literacy affects approximately 90 millions Americans, and costs the US health care approximately $73 billion annually in unnecessary doctor visits, hospitalizations, and longer hospital stays. A 1997 study of patients in 2 public hospitals found that those with inadequate literacy skills were 5 times more likely to misinterpret their prescriptions than patients with adequate reading skills, and they averaged 2 more doctors visits than those with marginal or adequate literacy skills. The 1992 National Adult Literacy Survey (NALS) which defines literacy as “using printed and written information to function in society,” found that 21% of Americans (40 to 44 million people) are functionally illiterate (reading below a fifth grade level), while an additional 27% of adults (50 million people) are only marginally literate (having difficulty with reading comprehension and/or computational skills).

“You can't tell by looking”: The AMA made a video designated by the above title, that tells the whole story. People from all ages, races, income and education levels are challenged by low health literacy. As Dr. Randolph Smoak, President of AMA, 2000-2001 put it, people suffering from low health literacy “can come from any part of the country; they can come from any social class. One thing they have in common is that you can't tell by looking.” Low health literacy affects all ethnic groups, with the greatest prevalence among native-born whites. Patients with low literacy are frequently ashamed and hide it. A 19966 study of patients with reading difficulty confirmed that 67% of them had never told their spouse and 19% had never told anyone about their reading problem. Low health literacy is particularly common among the older population and low-income people. More than 66% of US adults age 60 and over have either inadequate or marginal literacy skills; about 45% of all functionally illiterate adults live in poverty. One clear lesson stands out of the AMA video: “it is better to show and tell the patients what you want them to do.”

The launching of a national campaign: In 1998, AMA became the first national medical organization to adopt policy recognizing that limited patient literacy adversely effects medical diagnosis and treatment. Since then AMA Foundation has been working to raise awareness of health literacy within the health care community. At the 5^{th} Annual Health Literacy Conference on Sep. 19, 2002 in Washington D.C., Pfizer Inc. and the American Medical Association Foundation announced their partnership to address low health literacy and provide solutions for physicians and patients.

Hence what has been recognized as a need, but has heretofore been unavailable besides improvement of patients education pamphlets and literatures, is a more effective, and more efficient means, a user-friendly electronic system to meet the functional health literacy and numeracy challenges of patients, while ensuring accuracy in the administration or management of medications. The present invention fulfills this need and others.

### BRIEF DESCRIPTION OF THE DRAWINGS

FIG. 1 is an illustrative diagram showing the different functional units from care providers' ends capable of providing necessary inputs to patients' Medication Aid Personal Digital Assistant (“MedAid PDA or MedP”) for the purpose of enhancing safe medication use or administration in accordance with aspects of the present invention.

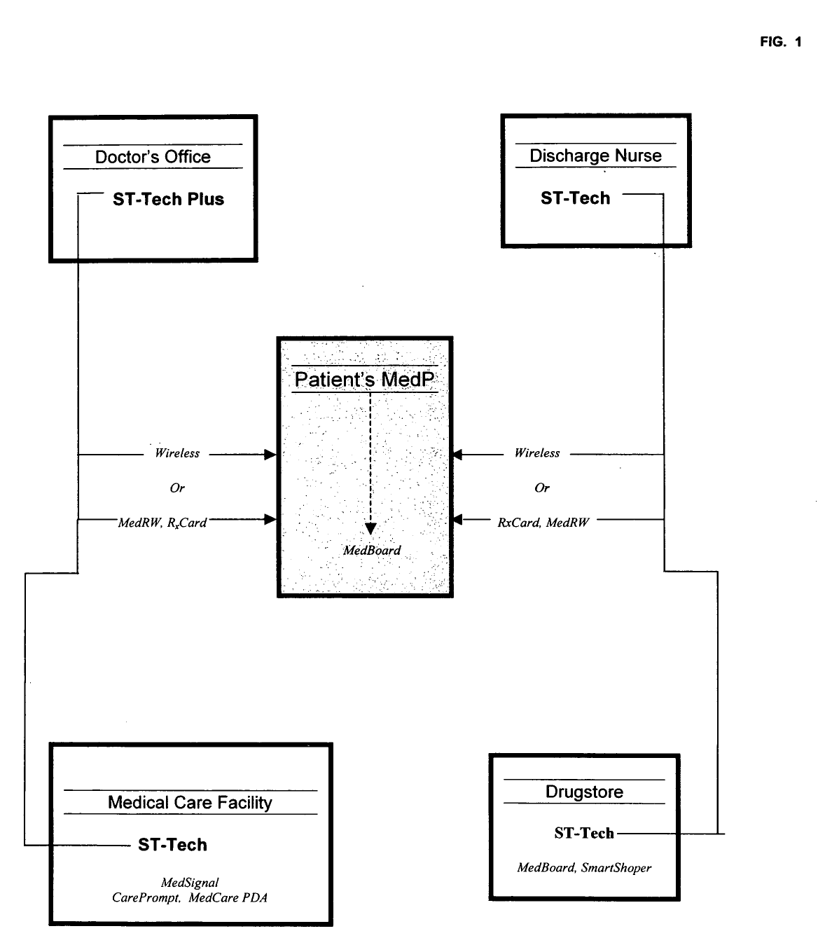

FIG. 2 is an alternative representation of a MedAid PDA with basic and user-friendly graphic interface to facilitate medication management in accordance with aspects of the present invention. The icons or signs of the present invention require extensive development and representation, not featured here.

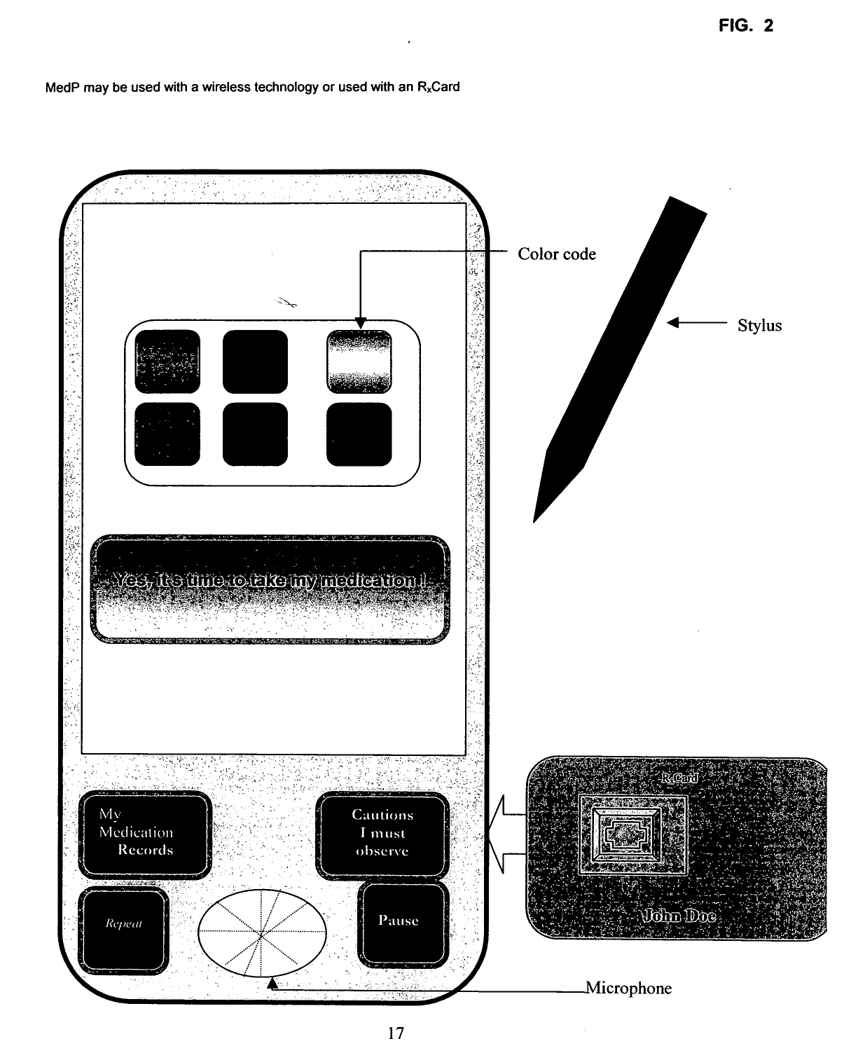

FIG. 3 is illustrative of SmartShoper, an embodiment of the present invention intended to provide information on potential interactions between herbal remedies or OTC and their prescribed drug regimen on MedP or RₓCard.

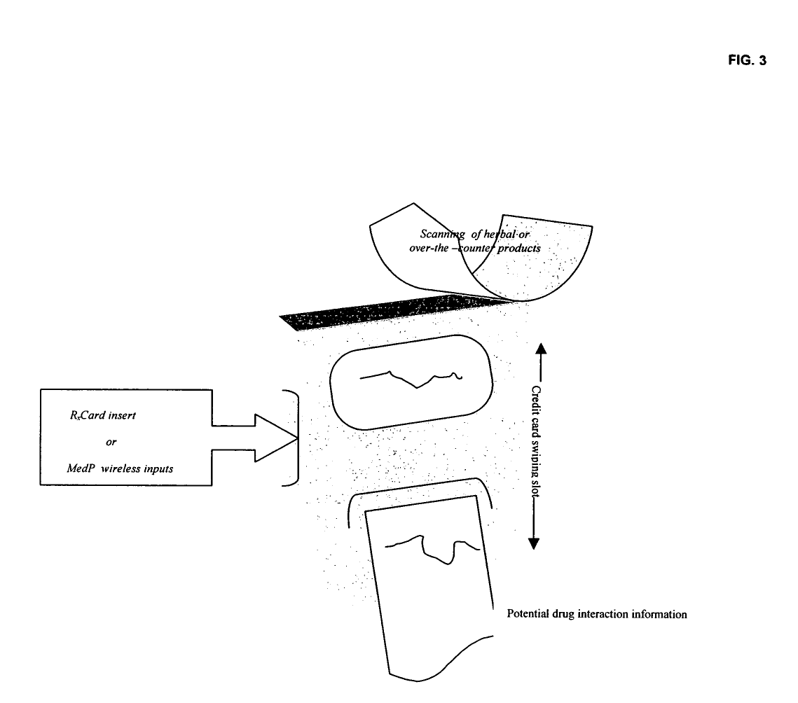

### BRIEF SUMMARY OF THE INVENTION

An object of the present invention is to provide a system that converts a text instruction into a vocal instruction with corresponding pictures and icons. This electronic conversion that shows and tells the matter of the instruction is designated as Show and Tell Tech (ST-Tech) Format. ST-Tech used in a medication management environment (“MedAid Environment”) is an electronic method to address patients' low health literacy and numeracy challenges, and enhance safe and effective health outcomes both outside and inside of healthcare providers' settings. ST-Tech Format can help 90 millions patients struggling with low health literacy, of whom 40 millions can't read and understand the headline of a newspaper, and 50 millions can't decide for a bus schedule.

To patients who can't read and understand health instructions, the system (“MedAid System”) composed of the ST-Tech and the MedAid environment offers useful features based on color code, pictures, voice and icons to help patients with their medication adherence and other medical and non-medical events.

Apart from the medication management features, MedAid System also offers patients the ability to have and carry an electronic copy of their own vital health information, and show, if need be, to a provider all the medications prescribed by other providers for safety sake.

To healthcare providers such as nursing homes, hospitals, and drugstore workers, the MedAid System provides a functional health literacy electronic solution to enhance patients' safe and effective medication use. Depending on setting of use, the MedAid System comprises a functional unit based on at least two specific devices intended to minimize the risk of medication errors, and to enhance the health outcomes, from the healthcare workers' ends to the patients' ends. MedAid System is a comprehensive tool to make clear and simple medical care instructions for patients through the use of audiovisual aids.

“MedBoard,” an electronic display board in the MedAid environment helps foster patient safe and effective medication use through ST-Tech Format, and to enhance patient/provider communication during a patient counseling process.

The development of MedAid Environment's applications as possible Add-ins to existing medical, nursing or pharmacy software application already on the market place. MedAid Environment provides portable medical information readily available on MedP in emergency situations regardless of the consciousness of the patient. All that patients need is to have a wireless MedP or a MedP with its inserted medication record device (“RₓCards”).

No single entity has to acquire every component of the MedAid Environment. But for each health service provider, MedAid Environment offers one or two devices aimed at addressing the universal and prevailing patient safety and low health literacy issues through ST-Tech.

A MedAid Environment is a suggested aggregate of software and hardware, which can be interconnected in various, and optional ways depending on the convenience, needs, and financial capacity of the users. Most of the technologies in a MedAid Environment are already on the market, and are being improved everyday. While these technologies are evolving into shape, form and capacity they can only enhance ST-Tech. The fundamentals or principles of the later will remain the same, namely, “show the medications and tell how to use take them with simple the signs or icons.

Hardware and software for patients' MedAid Environment may include but not limited to Portable Digital Assistance (PDA); an integrated circuit micro-processing device such as a Smart Card; and an electronic display board.

Hardware and software for providers' MedAid Environment may be a web-based system powered by one central hardware providing the ST-Tech features, and the other necessary operation platform, which all providers can share. Or a provider's MedAid Environment can simply be software of ST-Tech features purchased and owned by themselves.

Other accessory hardware and software for providers' MedAid Environment may include devices such as wireless technology in lieu of SmartCard reader/writer, and USB cradle.

The environment with web-based ST-Tech features: Any care facilities and drugstores with access to the internet can use this combination. Text entries will be converted by ST-Tech into its format and downloaded either directly on patients' Personal Digital Assistants or on their Smart Cards-whichever system is adopted.

The MedAid Environment with a ST-Tech software owned by providers: In this case, providers own the ST-Tech software. Text entries will be converted by ST-Tech into its format and downloaded either directly on patients' PDAs or on their SmartCards whichever system is adopted.

A MedAid Environment includes other optional but very useful devices already in use for medication management such as Paging system, Drug interaction-checking system, MedSignal.

Another element of the MedAid System is the “SmartShoper,” a device to enable patients to check out for themselves whether a non-prescription product (especially an herbal product) that they are considering to purchase does not have a known interaction with their prescribed medication regimens. Patients are often victims of quackery, as the plethora of herbal products on the market is non-regulated by the FDA, but some of them dangerously interact with prescription drugs. A patient will always have a handy, and up to date record of all the products (prescription and nonprescription) that they are taking. All these information including the herbs they are intending to use may optionally be recorded on their RₓCard and useful when they want to share them with their physicians or pharmacists.

### DETAILED DESCRIPTION OF (PREFERRED EMBODIMENTS) THE INVENTION

A system and method of managing a prescribed medication regimen is disclosed. The invention is primarily intended to help address the health literacy and numeracy challenging patients in their self-administration of prescribed medications. However, the system and method's purposes to help patients and their caregivers in this manner will be achieved only by the active conversion of the text instructions in the easy-to-understand by their physicians, pharmacists, and other medical care professionals. This invention is for the field of patient safety, however one skilled in the art can appreciate that it may be used in numerous applications for scheduled events or tasks. The goal is to help assist with problems in reading and understanding functioning on written instructions.

The ST-Tech software is to convert patients' medication instructions into an ST-Tech format; to edit existing records in the process as necessary; to facilitate refills by displaying, for each medication entered from the prescription list, the name, strength, picture, and exact location on the drugstore shelves; and to save the records into the drugstore's database. ST-Tech is developed (if possible) as an add-in program for drugstore's medication order processing programs already on the market place.

ST-Tech Plus software is to convert patients' medication instructions into an ST-Tech Format to edit existing records; to check patients' medication compliance; to build patients' compliance graphs from their medication use records as compiled by their personal MedAid home devices, to make for them copy of their health information upon request; and to save the records into the providers patients records database. The compliance graph for individual medications as well as the aggregate on the RₓCards compiled on the basis of missed dose events may allow providers short term (weeks) and long term (months) monitoring of their patients' medication adherence. ST-Tech Plus is developed (if possible) as an add-in program for Physician Order Entry programs already on the market place.

MedSignal is a software application to help manage efficiently medication administration and other pre-programmed tasks. The program automatically alerts and displays healthcare workers' tasks within every one or two hours time frame of a shift, and dispatches wirelessly these tasks to the assigned point of care devices which could work in conjunction with an optional paging system. At the appointed time, the alert signal beamed by MedSignal goes to the point of care device and the pager mounted on a wrist bracelet, while the program also simultaneously brings up the to the medication administration information on the screens of the point of care device and the computer where it is loaded. MedSignal also generates and prints patients' bar-coded identification for wristband-intended to link patients to their electronic medical records in the care providers' database. MedSignal is therefore developed to communicate with the computerized database of the health service or care provider for patient identification. In addition to the above features, MedSignal also includes ST-Tech to converts patients' medication for MedP.

MedRW is a medication record Reader & Writer designed to work with ST-Tech, ST-Tech Plus, and MedSignal in order to write and read patients' medication records.

RₓCard is an Integrated Circuit (IC) Microprocessor device where data can be stored and manipulated. The technology is rapidly evolving but available today as Smart Card. Today, RₓCards can be a Smart Card to store medication records, providers' and emergency contacts, allergies, health informationrinstructions or any important and relevant information, in the form of text, picture, voice, video-image or other multimedia forms of communication, with such features as interoperability, versatility, large memory, and high security. MedRW writes on RₓCards, and RₓCards data are write-protected, accessible only through passwords except for patients' own names, and providers and emergency contacts' information. Recorded health information on RₓCards are not accessible without the patient's own consent with another password disclosure. RₓCards can be excluded from MedAid System making the patient personal digital assistant described below, the sole data storage device at the patient's disposal.

MedAid PDA is a MedAid personal digital assistant (or MedP) for patients. It is a handheld electronic device, voice and wireless-enabled, is designed to alert patients when it is time to take medications; and to talk and show them their medication self-administration instructions into ST-Tech Format (pictures, signs, icons, text, etc). The records on the RₓCards (or inside MedAid's own memory) are write-protected, making it impossible for patients to proceed to any modification on their own. They are also accessible by password only. A special code for Paramedical Agencies only, may allow these agencies to access patients' information on their MedP in the event of medical emergencies. MedP automatically generates compliance parameters for charting, and encompasses an interactive system for recording challenges in complying with the prescribed medications, as well as the instructions to make up for their missed doses, as necessary. MedP is patients' response sensitive. It counts the number of pills being taken in accordance with the patient's responds to its prompts, and automatically displays the number of pills that is supposed to be remaining in a medication bottle, based on the starting time preset by the provider or pharmacist. The use of MedP may be facilitated by pre-recorded vocal instructions to help the user. Repeat and pause options in the process of playing or retrieving records may also be helpful. MedP may also have the following additional features, namely, outlets for earphone, speaker, microphone, adjustable volume, color display screen, and the option easily to change or set themselves their next medical appointment, other medical or non medical events on alarm. Details of MedAid functioning are described further in the drawings section of this document.

As the personal device to help patients adhere safely and effectively to their medication regimen, MedP must be really easy to use. The primary goal is to prompt patient each time, speak to them, and show them or their caregiver what to do.

To check a medication record MedP be operated as follows: Simply press medication record button to hear and see all medications' names, number of pills to remain in each bottle, missed doses.

Press cautions button to see and hear all contra-indications and precautions on the recorded medication regime.

To checking instructions for a specific medication: Double press medication records buttons. Then press coding color of that specific medication to hear and see corresponding medication use instructions for 24 hours, name, picture of the pills, icons and words precautions and contra-indications etc.

MedP gives an alarm when for the time to take a medication. Caregiver or patient acknowledges the prompt or agree to take the medication by pressing on MedP's screen “yes, it's time to take my medication” of. MedP displays all the patients' medications' coding colors, then indicates the one medication to take by saying the coding color of the bottle. For example, “press green, yes green! . . . ”. The green color starts blinking. When patient presses the right code (green in this case), MedP responds “yes, take the medication with green label, it is ibuprofen.” All other coding colors disappear, only ibuprofen coding color (the green) remains, and increases size to appear as a label with the name Ibuprofen on it. MedP continues then by telling the patient the dosage and precautions, if any, “take 2 tablets”, “with food” etc., all these reinforced by visual aids, namely, display of medication's name, pill's picture, and icons for dosage and precautions.

In case there are multiple medications, four for instance. When caregiver or patient presses on “it's time to take my medication” after the alarming prompt, MedP displays all the medications' coding colors, then starts saying: “you have four medications to take.” MedP indicates which medication to take by saying the coding color of the bottle: “press green, yes green”. And the green color starts blinking. The instructions for the first medication will start like in the scenario described earlier for the single medication Ibuprofen. For the second medication, MedP says “for your next medication, press purple, yes purple” for instance. The green ibuprofen label disappears, and the purple color starts blinking among all the other remaining colors. When caregiver or patient presses the purple button, MedP assists you as it did earlier with Ibuprofen. If you don't press the purple color for the next medication, MedP pauses (2 min), then repeats the message 2 times before starting the alarm again (10 min), till you press the indicated color for the next medication. After the last medication, MedP says “You would have taken 4 medications, your next medication time is at 6 o'clock p.m.” for instance.

MedCare PDA (or MedCare P), a handheld wireless point of care device allows users to instantly view the information relating to the task, which the corresponding computer (with MedSignal) is urging to carry out. This personal digital assistant for caregivers administering medications saves them many trips to the computers supporting MedSignal. MedCare P performs safety check with its built-in bar code scanning system, and gives MedSignal a feedback to record with the users acknowledgement that the medication was administered or not. Apart from medication administration, healthcare workers can make their duties easy and effective by scheduling on alarm other critical tasks for MedSignal to manage in conjunction with their MedCare Ps. MedCare P, and MedP can both produce a direct audible alarm with flashing light (as an option), to allow users to do away with their wrist pagers at their discretion.

MedBoard is a simple electronic display board, to magnify on a large screen the outputs (texts and images) of MedAid, ST-Tech, and ST-Tech Plus. It's a flat color panel with speaker to put on stand, or to mount on wall. MedBoard may be useful to elderly patients in their own homes, and equally useful in drugstores and doctors' offices, for patient counseling (as necessary) during visits or prescription refills. MedP, ST-Tech, ST-Tech Plus, and MedSignal, all operate MedBoard. Though MedBoard is an optional accessory its importance lies in the fact that large size images and texts are more senior friendly than smaller ones.

A paging system supported by short range wireless connectivity, on the one hand between computers running MedSignal and pagers designated as CarePrompts for caregivers'; and on the other hand a similar paging system between the MedP and wrist pagers known as MedPrompts for patients. The two paging devices can be mounted on wrist bracelets, and provide an alert system based on audible sound, or vibration coupled with flashing light, and a time clock, like common pagers. Contrary to CarePrompts, MedPrompts don't need a text display.

AcuRₓ, a scanning system, checks the accuracy of a product that is to be administered to a patient, before its actual administration. AcuRₓ compares the bar code of the product to that of the patient's ID wristband, to detect any mismatch (“wrong patient”, or “wrong age”, or “wrong medication”, or “wrong dosage or time”, etc.) As a bar code-based scanning system for patient safety, AcuRₓ must work in conjunction with the health service providers' computerized medical records and databases. AcuRₓ may be a stand-alone device, or built-in MedCare P. This second option may make easy and handy the view of medication administration orders followed by the scanning of bar codes on medication bottles and patient wristbands—with a single device.

The use of herbal products is not regulated, nor can medical providers control it. The SmartShoper is conceived as a stand alone device in drugstores, to help users cross-check by themselves the compatibility of prescribed medications from their RₓCards or MedPDA against the herbal or the over-the-counter (OTC) products that they are using or plan to buy on their own. This device may be supported via a high-speed internet connection linked to a drug/herb interaction checking system. A charge may apply to the use of SmartShoper through credit or check card transaction. SmartShoper scans the product's bar code, displays the finding (example: “duplication of drug,” or “drug interaction,” or “product unknown,” etc with the potential adverse events), with a printout with a disclaimer. SmartShoper may have the option to automatically record the findings on the users' device for subsequent or further discussions with the personal physician or the pharmacist.

At the doctor's office, ST-Tech Plus, MedRW, RₓCards and MedBoard represent a functional unit. With this functional unit, prescribers or their aids will be able to do the following: 1) read, alter, or create patients' medication records on their personal RₓCards; 2) Monitor the medication compliance of patients—especially those that have multiple doctors with subsequent risk of polypharmacy and duplication of drugs; 3) Show, discuss and explain to patients their new prescriptions or medication regimen with actual pictures of the products nom MedBoard (Show and Tell techniques); 4) Give an electronic copy of personal health information to patients upon request—as permitted by the Health Insurance Portability and Accountability Act (HIPAA); 5) By viewing patients' MedAid, care providers can check their compliance graphs and personally recorded challenges. By also listening to the recording, providers can then analyze and devise with patients the best plan to help them meet their compliance challenges. All the operations between ST-Tech Plus and MedP can be wirelessly performed with no need for RₓCards, if the wireless option turns out to be relatively more cost effective after evaluation.

At home, MedP, RₓCard, and MedBoard represent a functional unit. MedP manages patients' self-medication administration by sending signals to their personal MedPrompts. At an alert signal, a MedPrompt goes off indicating the prompt of specific information on the MedP. When patients reach out to their MedP, the device would show and tell them in their language what medication to take and how to take it, through very simple and interactive processes. MedP counts a non-response to three MedP prompt, within a 15-minute time frame as a “missed dose” event. After this “missed dose” event, any following interaction with MedP will prompt MedP to ask a question. Example: “John, you missed your Ibuprofen dose of 9 am. What happened?” MedP would then allow the patient to record his or her explanation for the “missed dose” event. After the recording, MedP would then tell the patient whether to make up for the missed dose or not-in accordance with the providers' preset instructions on “how to handle a missed dose” of that particular medication nom ST-Tech Format. All MedP outputs may be displayed in a magnified format on a color screen flat panel. At home, patients may use MedBoard, but they may use MedP alone and readily when they are away from home.

At a care facility such as hospital, nursing home, assisted living, etc. MedSignal, CarePrompt, and MedCare P represent a functional unit. MedSignal manages the medication administration tasks of multiple patients by sending signals to the CarePrompts assigned to these patients' caregivers. At the alert signal, a CarePrompt goes off, and displays the name, room, and bed number of the patient to whom a medication must be administered at that particular time. This is a call to the prompt of specific information on the computer that supports the corresponding MedSignal. A touch of that computer screen pops up the patient medication administration instructions along with all related precautionary measures. Instead of making a trip to the nurse station at each prompt, caregivers may simply use MedCare P to consult MedSignal, at the very place they happen to be when their CarePrompt went off. To be compliant with HIPPA regulations, a caregiver viewing a patient information will be logged off the system when he or she steps away from MedSignal Computer screen for a predetermined time by their nursing team.

Before a healthcare worker administers a drug to a patient, he or she may use AcuR, to scan the patient's bar-coded wristband. This allows AcuR, to pull up the patient's computerized medical record. The healthcare worker then scans the drug to be administered to the patient. This scan informs the AcuR, of which drug will be administered. The system then compares the patient's medical record to the drug being administered to ensure that they match what is prescribed for the patient. If there is a problem, the system sends an error message to AcuRₓ, and the healthcare worker investigates the problem. When AcuRₓ is built-in MedCare P, this device would simply be used to perform the scanning.

At discharge from the care facility, MedSignal, RₓCards, and MedRW may be used as a functional unit. With MedSignal, a discharge nurse would compare the old medication regimen on an RₓCards before admission, to the new prescriptions at discharge from the hospital, to detect potential duplication or drug interactions. After this safety check, the new medication regimen and the discharge instructions would be written on the patient's RₓCards in a ST-Tech Format with MedSignal and MedRW.

At the drugstore, ST-Tech, RₓCard, MedRW, MedBoard, and SmartShoper may be used: The Pharmacy technician or the pharmacist would use ST-Tech to do the following: 1) Compare the new prescriptions to existing records on the RₓCards; 2) See the location on the store's shelf, the picture, name and strength of the medication to be dispensed; 3) Convert the prescribed treatment into an ST-Tech Format for the patient; 4) Record the information on an RₓCards for the patient; 5) One-on-one patient counseling enhanced with magnified visual illustration by the MedBoard.

Patients may walk in the pharmacy at any time and privately: 1) Use their RₓCards and check/credit card to check out the compatibility of their herbal products and OTC with their prescribed regimen; 2) Get an electronic print of possible interaction of their regimen with the considered product; 3) Record their non-prescribed products on their RₓCards.

At the drugstore, patients may pick up their medications and updated RₓCards s or the MedPDA they handed to the pharmacist. When they get home, the only thing they have to do is insert their RₓCards into their MedPs, or use them alone, and be able to manage property their most complex medication regimen. The embedded ST-Tech features in these devices will tell them and show them what to do in real colors with voice assistance/reinforcement. State laws require pharmacists to provide patient counseling at the drugstore, and MedBoard may also enhance this process, with all the visual illustration of the patient actual pills.

Communication between all MedAid Environment devices is ensured by short-range wireless connectivity. Users of MedSignal, ST-Tech, and ST-Tech Plus can update some features of their programs on their own. Example: digital pictures taken by users can be added to ST-Tech system as deemed necessary by users themselves. Apart from the personal update workability, users can avail themselves of MedAid Environment support service, which would provide on an on-going basis new medication pictures as they are released on the market. This support service can be done through a registration program via the Internet. In addition to medication and health information, healthcare workers can also put on RₓCards for patients, other information such as doctors appointments, instructions for self-preparation before special procedures, as long as the device has high capacity with multimedia memory features. All MedAid Environment devices would be Windows or Mac based to allow addition into existing medical programs. They may function with wire connection or be wireless-whichever is more effective and more affordable.

The MedAid System may be based in its entirety on Bluetooth™ or wireless connectivity between its various devices. For example, a MedP may not use a smart card.

What is claimed is:

1. A system that converts the text entries of a medical prescription into a vocal instruction with corresponding pictures and icons. The name and strength of the prescribed medication are recognized in the text entry, and the corresponding picture available on records, for example Physicians Desk Reference, is pulled out of a database for display. A text-to-speech (TTS) technology renders the prescription instructions in audible voice. Specifics in the instructions such as do's and don'ts, for example, “don't drive, don't drink grape fruit juice,” are pulled from a database of still or animated pictures or icons for concomitant display. The rhythm of administration and dosage of the medication are also recognized in the text entry, and converted into the corresponding icons or signs available in the database.

2. The system of claim 1 wherein the TTS engine works with for different languages options or modules for example, Chinese, Spanish, French, etc.

3. The system of claim 1 wherein a mechanism allows the healthcare provider to replace or edit when necessary the computer generated TTS by an active human voice in out with microphone.

4. The system of claim 1 wherein the animated pictures or icons self-adjusting to dose, help illustrate the prescribed medication dosage in an accurate but easy-to-understand format for the patients.

5. The system of claim 1 wherein a provider has an option to choose from a panel of colors associated with a printing feature for color-code labels or stickers for medication bottles' color-coding.

6. The system of claim 1 wherein the signs or pictures to be used as icons for various cautions warnings or contra-indications or instructions are self-explanatory, and continuously developed and added to the database.

7. The system of claim 1 wherein a panel displays the time or frequency to select from, in order to set up simple medication taking or administration schedules or frequency.

8. The system of claim 1 wherein a medication compliance monitoring mechanism including automatic tracking of the expected number of pills, refills, missed doses, instructions to make up for missed doses as necessary, and an interactive mechanism for recording challenges in complying with the prescribed regimen.

9. The system of claim 8 wherein a mechanism of countdown of the number of expected pills in a medication bottle starts from the time of refill, with consideration to the frequency or rhythm of administration.

10. The system of claim 1 wherein a dating mechanism automatically gives notice about the time for new refills, end of medication administration, or expiration date.

11. The system of claim 1 wherein a feature automatically shuts down the alarm corresponding to the medications after their time for taking the actual last dose has elapsed.

12. The system of claim 1 wherein a feature gives an alarm with audible voice instructions for self-preparation prior to a special procedures or lab tests, as well as an automatic reminder of events such as next medical appointments.

13. The system of claim 1 wherein the healthcare provider has the option to add to the system other information including medical events created by themselves (with a distinctive proprietary mark) in text or other multimedia forms, to meet a special group or an individual patient's needs

14. The system of claim 1 wherein A prompt for users to enter a given user ID code as a signature in order to complete successfully any manipulating/altering process of a pre-existing data. This signature may be a digitally encrypted key “signature”, requiring a “private key”

15. The system of claim 1 wherein a log of all the patients' medications regimens related operations are automatically kept for any need of review by the primary care provider.

16. Another embodiment of the MedAid environment wherein patients remotely cross check themselves the compatibility of their medication regimen with a non prescription product they intend to purchase.

17. The detailed embodiment is illustrative only and should not be taken as limiting the scope of the present invention. Many variations, modifications, and other uses may be made without departing from this invention. Accordingly, I claim as my invention all such modifications as may come within the scope and spirit of the following claims and equivalents thereto.
